(19) United States
(12) Patent Application Publication
(10) Pub. No.: US 2008/0309455 A1
(43) Pub. Date: Dec. 18, 2008

(54) SYSTEM AND METHOD FOR OPERATING A MOVEABLE BARRIER OPERATOR

(75) Inventors: Ronald David Brogle, Addison, IL (US); Frank Garrett, Barrington, IL (US); Michael C. Garrett, Wilmette, IL (US); Robert Roy Keller, JR., Park Ridge, IL (US); Hamin Tien, Hoffmann Estates, IL (US); Edward Lukas, Batavia, IL (US); Eric Templeton, Lombard, IL (US)

Correspondence Address: FITCH EVEN TABIN AND FLANNERY, 120 SOUTH LA SALLE STREET, SUITE 1600, CHICAGO, IL, 60603-3406, US

(73) Assignee: THE CHAMBERLAIN GROUP, INC., Elmhurst, IL (US)

(21) Appl. No.: 11/761,887

(22) Filed: Jun. 12, 2007

(51) Int. Cl. G06K 9/00

(52) U.S. Cl. 340/5.7; 382/116; 713/182

(57) ABSTRACT

In some of these approaches, a first fingerprint of a first user is stored in a memory and the transmission of an activation code is authorized. Subsequently, the first fingerprint is re-sensed and authenticated and a second fingerprint of a second user is responsively sensed and stored. The activation code is transmitted to the moveable barrier operator upon subsequent authenticating of the second fingerprint. Subsequently, the second fingerprint is re-sensed and authenticated and a third fingerprint of a third user is responsively sensed and stored. The activation code is transmitted to the moveable barrier operator upon subsequent authenticating of the third fingerprint.

### CROSS REFERENCE TO RELATED APPLICATIONS

SYSTEM AND METHOD FOR OPERATING A MOVEABLE BARRIER OPERATOR being filed on the same date as the present application and having attorney's docket number 5569/90367, the contents of which are incorporated herein by reference in its entirety.

### FIELD OF THE INVENTION

The field of the invention relates to moveable barrier operators and, more specifically, to actuating moveable barrier operators.

### BACKGROUND

Different types of moveable barrier operators have been sold over the years and these barrier operator systems have been used to actuate various types of moveable barriers. For example, garage door operators have been used to move garage doors and gate operators have been used to open and close gates.

Such barrier movement operators may include various mechanisms to open and close the barrier. For instance, a wall control unit may be coupled to the barrier movement operator and sends signals to a head unit thereby causing the head unit to open and close the barrier. In addition, operators often include a receiver unit at the head unit to receive wireless transmissions from a hand-held code transmitter or from a keypad transmitter, which may be affixed to the outside of the area closed by the barrier or other structure.

The keypads and other transmitter devices may utilize various types of interfaces to allow a user to actuate the barrier and these different interfaces may provide security features that prevent unauthorized users from accessing the system. In one example, a fingerprint sensing device can be used to allow the user to actuate the barrier and to provide security when conducting barrier actuation operations.

In these previous fingerprint-based barrier actuation systems, an administrator solely controlled access to the system. More specifically, this single administrator had complete control when adding new users and deleting current users.

Unfortunately, problems relating to the single administrator architecture of previous systems have occurred. For example, if the administrator was not present or available to conduct their duties and/or was uncooperative in the performance of their duties, the ability to add or delete users was unavailable. For example, in households undergoing a divorce, the administrator (i.e., either the husband or wife) was sometimes unwilling to cooperate with the other person in order to add or delete users. These problems created user frustration with the system and situations where a user could not gain access to the system.

In other situations when actuating a moveable barrier, it is sometimes necessary or desirable to alter or adjust the actuation of the barrier after a previous actuation has been selected and/or is being implemented. For example, when a door is in the process of being opened, it may be later decided that the movement of the door should be halted or reversed. In previous fingerprint-actuated systems, the initial reading and verification of a fingerprint allowed a door to be opened. However, in order to close or halt movement of the door, a second time-consuming fingerprint reading and verification were required to halt the movement of the door. This second required reading and verification created problems in emergency situations where quick action (e.g., halting movement of the door when an object was in the pathway of the door) was required. As with the other problems described above, user frustration with the system developed and the efficiency of the system decreased in these situations.

### SUMMARY

Approaches are provided that provide adequate security in fingerprint-based barrier actuation systems but that do not rely on a single administrator. In these approaches, a trusted group of fingerprint users is established and any member of the trusted group can add and/or delete members from the group. In so doing, the disadvantages of having a single administrator with complete control over the adding or deleting of members authorized to use the system are reduced or eliminated.

As described herein, a first fingerprint of a first user is stored in a memory and the transmission of an activation code is authorized. Subsequently, the first fingerprint is re-sensed and authenticated and a second fingerprint of a second user is responsively sensed and stored. The activation code is transmitted to the moveable barrier operator upon subsequent authenticating of the second fingerprint.

Subsequently, the second fingerprint is re-sensed and authenticated and a third fingerprint of a third user is responsively sensed and stored. The activation code is transmitted to the moveable barrier operator upon subsequent authentications of the third fingerprint.

Various modes may be used within the system. For example, a storage mode may be selected and entered after authenticating either the second finger print or the third fingerprint. Other types of modes may also be used.

In other approaches described herein, all of the fingerprints in storage from the memory may be erased and the activation code may be changed. In still other examples, one or more (but not all) of the fingerprints in storage from the memory can be erased and the activation code can be changed.

The activation codes may be in a variety of forms. For instance, these codes may be rolling codes or fixed codes. Other examples of codes or coding schemes are possible.

In other approaches, a first fingerprint can be sensed and stored and an activation code authorized. Thereafter, a second fingerprint can be sensed and stored. Then, the first fingerprint can be re-sensed and authenticated. The activation code may be sent to the barrier operator based upon subsequent authentications of either the first or the second fingerprint. A third fingerprint can be subsequently sensed and stored, and the second fingerprint can be re-sensed and authenticated. Thereafter, the activation code is sent to the moveable barrier operator upon subsequent authentications of any of the first, second, or the third fingerprint.

In still other approaches described herein, reading the fingerprints is order-independent. More specifically, a first fingerprint of a first user may be sensed and stored in memory and an authorization may be made to transmit the activation code and enable future fingerprint transmissions. Subsequently, a second fingerprint is sensed and the first fingerprint authorizes the storing of the second fingerprint.

The activation code is transmitted to the moveable barrier operator upon subsequent authentications of the second fingerprint. Subsequently, a third fingerprint is sensed and the second fingerprint authorizes the storage of the third fingerprint. The activation code is transmitted to the moveable barrier operator upon subsequent authentications of the third fingerprint.

Multiple new fingerprint entries can also be made with a single authorization. For example, a first fingerprint may be sensed and stored in memory authorizing the system to transmit an activation code and enabling fingerprint authorizations. Subsequently, a second fingerprint of a second user and a third fingerprint of a third user are sensed and the first fingerprint authorizes the storage of the second fingerprint and the third fingerprint. The activation code is then transmitted upon subsequent authentications of either the second fingerprint or the third fingerprint.

Thus, approaches are provided where a trusted group of fingerprints associated with different users can be created. Each of the trusted fingerprints can be used to add and/or delete fingerprints (i.e., associated with particular users) to or from the trusted group. Consequently, a single administrator no longer has complete control over the entry system thereby improving the user experience with the system.

### BRIEF DESCRIPTION OF THE DRAWINGS

FIG. 1 is block diagram of a fingerprint entry system for a moveable barrier operator according to various embodiments the present invention;

FIG. 2 comprises a flowchart of one example of the operation of a fingerprint entry system according to various embodiments of the present invention;

FIG. 3 comprises a flowchart of another example of the operation of a fingerprint entry system according to various embodiments of the present invention;

FIG. 4 comprises a flowchart of still another example of the operation of a fingerprint entry system according to various embodiments of the present invention;

FIG. 5 comprises a flowchart of yet another example of the operation of the fingerprint entry system according to various embodiments of the present invention; and

FIG. 6 comprises a block diagram of a fingerprint reading device according to various embodiments of the present invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DESCRIPTION

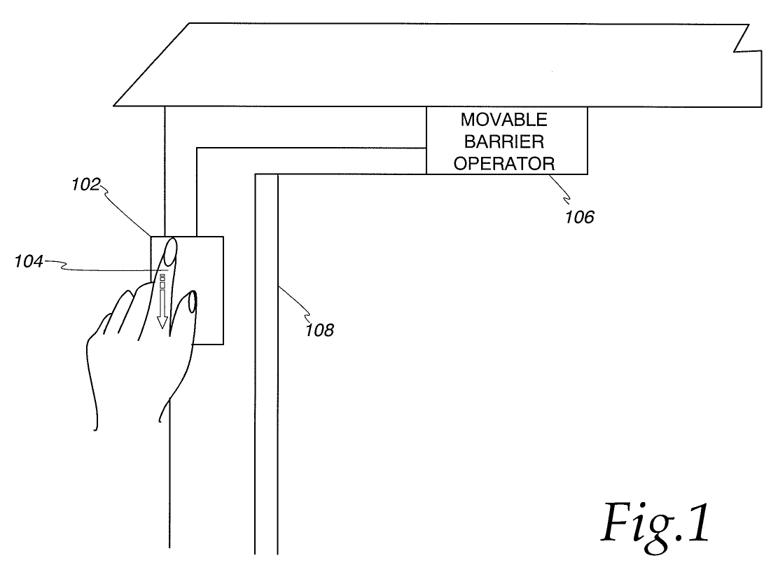

Referring now to FIG. 1, one example of a fingerprint entry system used to actuate a moveable barrier is described. The system includes a fingerprint reading apparatus 102, a moveable barrier 108, and a moveable barrier operator 106.

The fingerprint reading apparatus 102 is any device that is capable of reading and analyzing fingerprints. In this regard, the fingerprint reading apparatus 102 may be a scanner that reads and authenticates fingerprints according to any known approach or technique. For instance, the fingerprint reading apparatus 102 may include sensors to detect a fingerprint and a processor or processing device to compare the fingerprint to previously verified or learned fingerprints. The fingerprint reading apparatus 102 may be a fixed device (e.g., a keypad coupled to a building) or a portable device (e.g., a wireless transmitter).

The moveable barrier 108 may be any type of barrier including a garage door, a swinging door, a sliding gate, a swinging gate, or shutters. The moveable barrier operator 106 can be any type of operator used to actuate a barrier such as a garage door operator or gate operator. Other types of barriers and barrier operators are possible.

In one example of the operation of the system of FIG. 1, the presence of a first human fingerprint is detected at the fingerprint reading apparatus 102. For example, a user may slide their finger across a sensor at the fingerprint reading apparatus 102 and the presence of the finger and fingerprint are sensed. The first human fingerprint is analyzed to determine whether it has been previously learned or verified by the fingerprint reading apparatus 102.

When the first human fingerprint is determined to have been previously learned, a first command is sent to actuate the moveable barrier operator 106. Within a predetermined time period after the first human fingerprint has been determined to be previously learned, the presence of a second human fingerprint is sensed at the fingerprint reading apparatus 102. Without analyzing the second fingerprint, a second command is sent to actuate the moveable barrier operator 106. Alternatively, the second command can be originated by setting a switch (or other input device) and the fingerprint sensor can be used for other purposes. The first fingerprint and the second fingerprint may be from the same or different users.

The predetermined time period selected may vary based upon the needs of the user or system. In one example, the time period may correspond to the time needed to open or close the door. In still other examples, the time period may be much longer, such as hours.

The first command and the second command may be selected from a variety of different commands. For example, the first command and the second command may be open commands, close commands, or halt movement commands. In some examples, the first command and the second command are different commands. However, in other situations, the first and second commands may be the same command.

In another example of the operation of the system of FIG. 1, a first fingerprint of a first user is stored in a memory at the fingerprint reading apparatus 102 and the transmission of an activation code is authorized. Subsequently, the first fingerprint is re-sensed and authenticated and a second fingerprint of a second user is responsively sensed and stored at the fingerprint reading apparatus 102. The activation code is transmitted to the moveable barrier operator 106 upon subsequent authentications of the second fingerprint.

Subsequently, the second fingerprint is re-sensed and authenticated by the fingerprint reading apparatus 102 and a third fingerprint of a third user is responsively sensed and stored at the fingerprint reading apparatus 102. The activation code is transmitted to the moveable barrier operator 106 upon subsequent authentications of the third fingerprint.

In this way, a trusted group of fingerprints can be created with each fingerprint associated with a different user. Once a fingerprint is included in the trusted group, that fingerprint can be used to add additional fingerprints (i.e., associated with new users) to the group and/or remove fingerprints (i.e., users) from the group. In other words, a single administrator is not used and any authorized user can add or delete other users.

Various modes of operation may also be used within the system. For example, a storage mode may be selected and entered after authenticating either the second fingerprint or the third fingerprint. In one example, the storage mode (or other modes) can be selected with actuators (e.g., buttons or switches) at the fingerprint reading apparatus 102.

In other approaches, all of the fingerprints stored at the fingerprint reading apparatus 102 may be erased and the activation code may be changed. In still other examples, one or more (but not all) of the fingerprints in storage in the memory of the fingerprint reading apparatus 102 can be erased and the activation code can be changed. In other examples, only the fingerprints are erased and the activation code is left unchanged.

The activation codes may assume a variety of forms. For example, the activation codes may be rolling codes or fixed codes. Other examples of codes and code combinations are possible.

In other approaches, the first fingerprint can be sensed and stored and an activation code authorized. Thereafter, the second fingerprint can be sensed and stored. Then, the first fingerprint can be re-sensed and authenticated. The activation code may be sent to the barrier operator based upon subsequent authentications of the second fingerprint. A third fingerprint can be subsequently sensed and stored, and the second fingerprint can be re-sensed and authenticated. Thereafter, the activation code is sent to the moveable barrier operator upon subsequent authentications of the third fingerprint.

In still other examples, the reading of the fingerprints by the system is order-independent. More specifically, a first fingerprint of a first user may be sensed and stored in memory at the fingerprint reading apparatus 102 and an authorization may be made to transmit the activation code and enable future activation code transmissions. Subsequently, a second fingerprint is sensed and the first fingerprint authorizes the storing of the second fingerprint at the fingerprint reading apparatus 102.

The activation code is transmitted to the moveable barrier operator 106 upon subsequent authentications of the second fingerprint by the fingerprint reading apparatus 102. Subsequently, a third fingerprint is sensed and the second fingerprint authorizes the storage of the third fingerprint at the fingerprint reading apparatus 102. The activation code is transmitted to the moveable barrier operator 106 upon subsequent authentications of the third fingerprint.

Multiple new entries can also be made with a single authorization. For example, a first fingerprint may be sensed and stored in memory at the fingerprint reading apparatus 102 thereby authorizing the system to transmit an activation code and enabling fingerprint authorizations. Subsequently, a second fingerprint of a second user and a third fingerprint of a third user are sensed at the fingerprint reading apparatus 102 and the first fingerprint authorizes the storage of the second fingerprint and the third fingerprint. The activation code is transmitted upon subsequent authentications of either the second fingerprint or the third fingerprint.

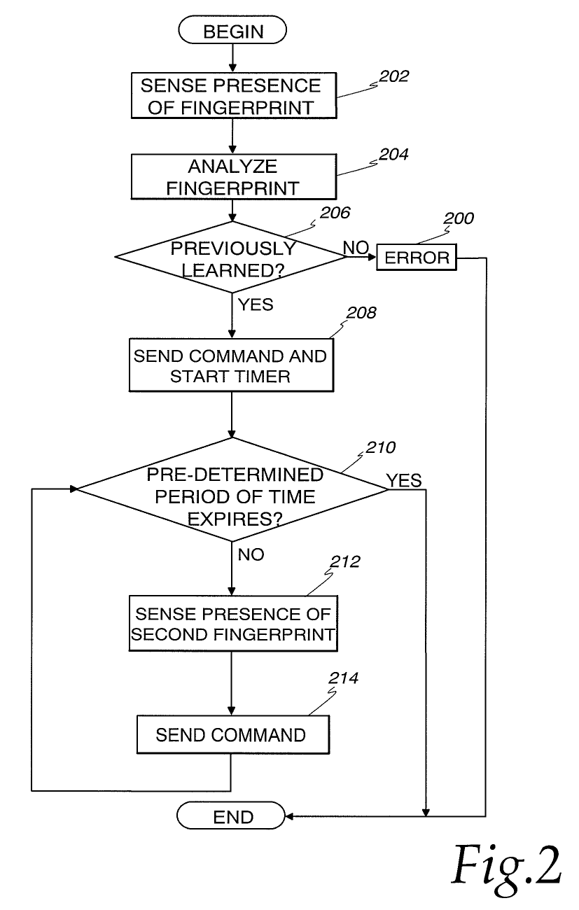

Referring now to FIG. 2, one example of an approach for operating a fingerprint entry system to actuate a moveable barrier is described. At step 202, the presence of a first fingerprint is sensed. For example, a user may slide their finger over a sensor or sensing device and the sensor or sensing device may detect that the finger and the fingerprint are present. At step 204, the fingerprint is analyzed to determine its characteristics. For example, patterns or other defining characteristics of the fingerprint may be determined. At step 206, the analyzed fingerprint is compared against other previously verified fingerprints to see if the fingerprint has been previously learned. If the answer at step 206 is negative, then at step 208 an error is sent to the user (e.g., informing the user that the user is not allowed to access the system) and the user is not allowed to access the system.

If the answer at step 206 is affirmative, then at step 208, a command is sent to the moveable barrier operator and a timer is started and set to expire after a predetermined time period has elapsed. The command may be any type of command such as a command to activate the barrier. The nature of the command may depend upon the state of the barrier/barrier operator. For example, an open command may be sent if the barrier is closed or a close command may be sent if the barrier is open. At step 210, it is determined if the predetermined time period of the timer has expired. If the answer is affirmative, execution ends. If the answer is negative, execution continues at step 212.

At step 212, the presence of a second fingerprint is sensed. This fingerprint can be of any user. At step 214, a command is sent to the moveable barrier operator without verifying the second fingerprint. As before, the command may be any type of command to activate the barrier. The nature of the command may depend upon the state of the barrier/barrier operator. For example, an open command may be sent if the barrier is closed or a close command may be sent if the barrier is open. Execution then continues with step 210 as described above.

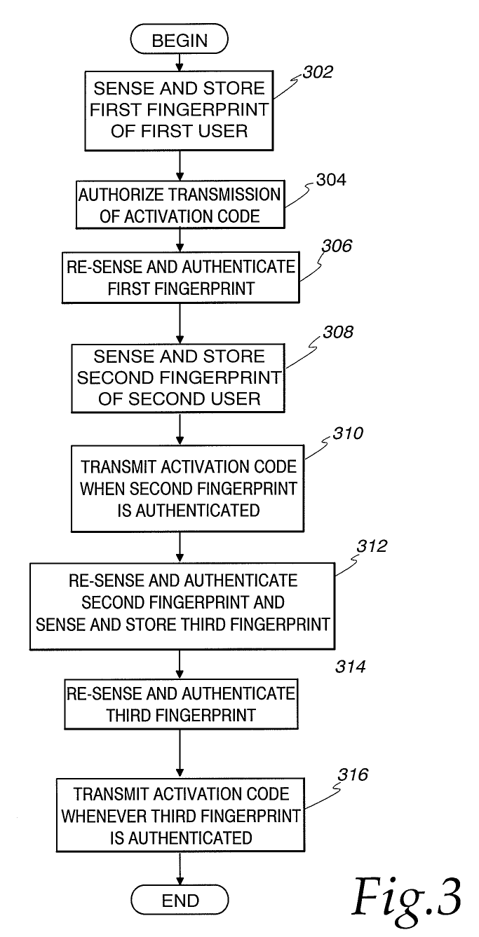

Referring now to FIG. 3, one example of an approach for operating a fingerprint entry system to actuate a moveable barrier is described. At step 302, a first fingerprint of a first user is stored in a memory. At step 304, an activation code is authorized to be transmitted. Subsequently, at step 306, the first fingerprint is re-sensed and authenticated. At step 308, a second fingerprint of a second user is responsively sensed and is stored in memory because of the re-sensing and authentication of the first fingerprint.

At step 310, the activation code is transmitted to a moveable barrier operator upon subsequent authentications of the second fingerprint. At step 312, the second fingerprint is re-sensed and authenticated and a third fingerprint of a third user is sensed, authenticated and stored in the memory. At step 314, the third fingerprint is re-sensed and authenticated. At step 316, the activation code is transmitted to the barrier operator upon subsequent authentications of the third fingerprint.

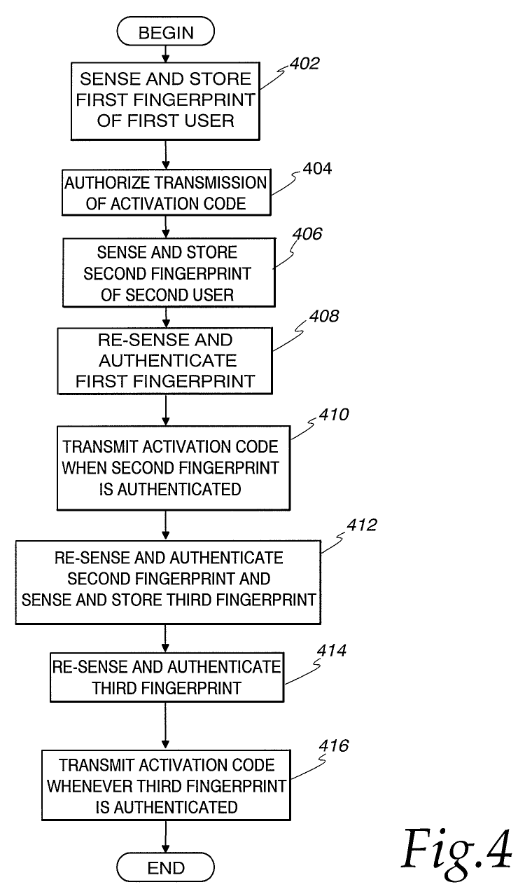

Referring now to FIG. 4, another approach for actuating a movable barrier operator using a fingerprint sensing system is described. At step 402, the first fingerprint is sensed and stored in memory and at step 404 an activation code is authorized to be transmitted. Thereafter, at step 406 the second fingerprint is sensed and stored. Then, at step 408 the first fingerprint is re-sensed and authenticated. At step 410, the activation code is sent to the barrier operator based upon subsequent authentications of the second fingerprint. At step 412, a third fingerprint is subsequently sensed and stored, and the second fingerprint is re-sensed and authenticated. Thereafter, the third fingerprint is re-sensed and authenticated at step 414 and at step 416 the activation code is sent to the moveable barrier operator upon these subsequent authentications of the third fingerprint.

In other approaches, the reading of the fingerprints is order-independent. More specifically, a first fingerprint of a first user may be sensed and stored in memory and an authorization may be made to transmit the activation code and enable future fingerprint transmissions. Subsequently, a second fingerprint is sensed and the first fingerprint authorizes the storing of the second fingerprint. The activation code may be transmitted upon future authentication of the second fingerprint.

Multiple new entries can also be made with a single authorization. For example, a first fingerprint may be sensed and stored in memory authorizing the system to transmit an activation code and enabling fingerprint authorizations. Subsequently, a second fingerprint of a second user and a third fingerprint of a third user are sensed and the first fingerprint authorizes the storage of the second fingerprint and the third fingerprint. The activation code is transmitted upon subsequent authentications of either the second fingerprint or the third fingerprint.

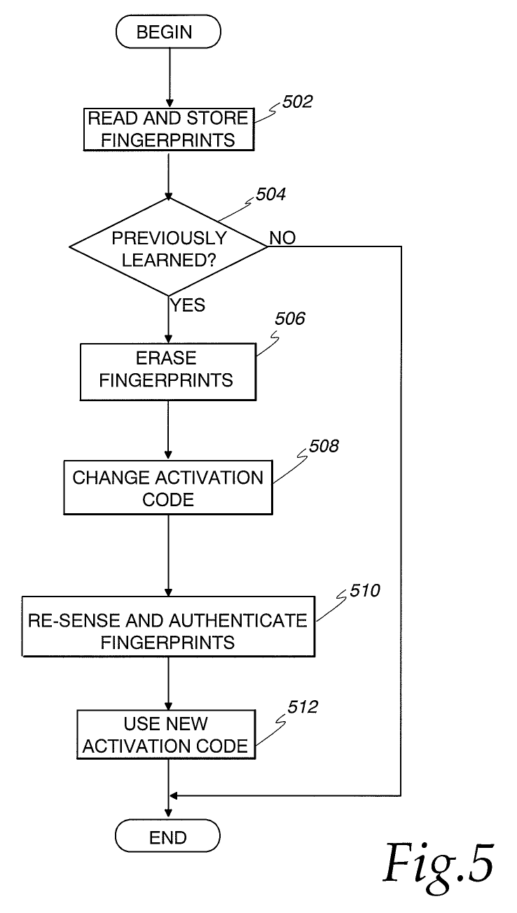

Referring now to FIG. 5, another approach for operating a fingerprint entry system to actuate a moveable barrier is described. In this example, various fingerprints are stored in memory of a fingerprint reading apparatus. At step 502, a fingerprint is read and at step 504 it is determined if the fingerprint has been previously learned or verified. If the answer is negative, execution ends. If the answer is affirmative, then at step 506 the fingerprints are erased from memory. All or some of the fingerprints may be erased. At step 508, the actuation codes are changed in memory. For example, a previous rolling code sequence may be changed to a new rolling code sequence. In an alternative approach, step 508 may be omitted (i.e., the activation code is left unchanged).

At step 510, at a subsequent time, the fingerprints are re-sensed and re-authenticated. At step 512, a new activation code is used. In one example, this may be a new rolling code sequence.

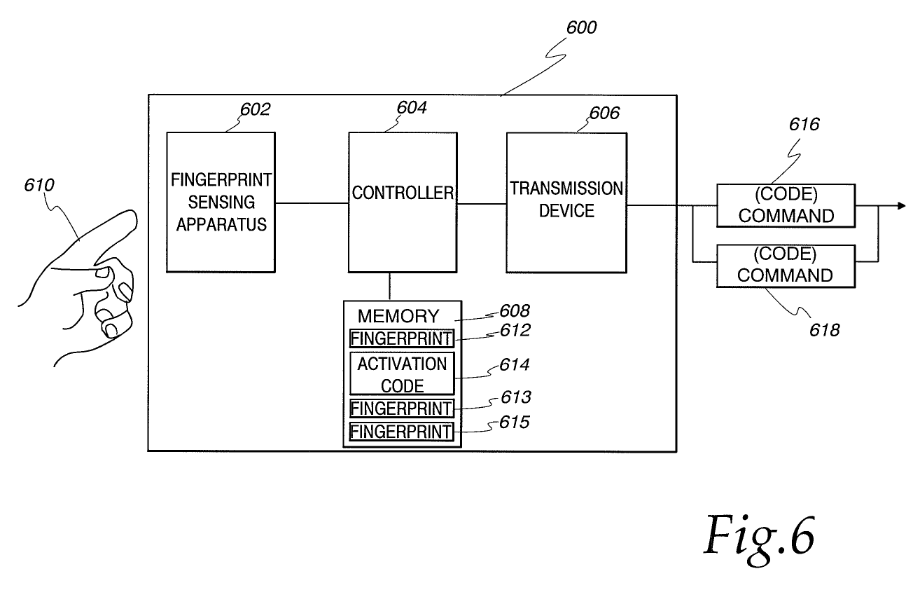

Referring now to FIG. 6, one example of a fingerprint entry device 600 (e.g., the fingerprint reading apparatus 102 of FIG. 1) to actuate a moveable barrier is described. The device 600 includes a fingerprint sensing apparatus or sensor 602, a controller 604, a transmission device 606, and a memory 608. A hand 610 with a finger is swiped over the fingerprint sensing apparatus 602 to provide the first fingerprint.

In one example of the operation of the device 600, the controller 604 is adapted and configured to analyze and determine whether the first human fingerprint has been previously learned by the barrier movement operator. When the first human fingerprint is determined to be previously learned, a first command 616 (having an activation code) is sent to actuate a moveable barrier operator. Within a predetermined time period after the first human fingerprint has been determined to be previously learned, the presence of a second human fingerprint is sensed at the fingerprint sensing apparatus 602. Without analyzing the second fingerprint, a second command 618 is sent to actuate the moveable barrier operator. The first fingerprint and the second fingerprint may be from the same or different users.

In another example of the operation of the device of FIG. 6, the controller 604 is configured and arranged to store a first fingerprint 612 of a first user in the memory 608 that was sensed at the fingerprint sensing apparatus 602, and authorize the transmission of an activation code 614. The controller 604 is arranged and configured to subsequently authenticate the first fingerprint that is re-sensed at the fingerprint sensing apparatus 602 and responsively store a second fingerprint 613 of a second user sensed at the fingerprint sensing apparatus 602 in the memory 608. The controller 604 is arranged and configured to transmit the activation code 614 to a moveable barrier operator at the output of the transmission device 606 upon authentication of the second fingerprint 613. The controller 604 is also arranged and configured to subsequently authenticate the second fingerprint 613 re-sensed at the fingerprint reading apparatus 602 and responsively store a third fingerprint 615 of a third user sensed at the fingerprint reading apparatus 602. The controller 604 is arranged and configured to transmit the activation code 614 to the moveable barrier operator at the output of the transmission device 606 upon subsequent authenticating of the third fingerprint 615.

As described elsewhere in this specification, the controller 604 can also be arranged and configured to read fingerprints in an order-independent sequence. In still other examples, multiple fingerprints can be sensed and stored in the memory 608 based upon a single fingerprint authorization.

Those skilled in the art will recognize that a wide variety of modifications, alterations, and combinations can be made with respect to the above described embodiments without departing from the spirit and scope of the invention, and that such modifications, alterations, and combinations are to be viewed as being within the scope of the invention.

What is claimed is:

1. A method of operating a moveable barrier operator using a fingerprint authorizing apparatus, comprising:
sensing and storing a first fingerprint of a first user in a memory, and authorizing the transmission of an activation code;
subsequently re-sensing and authenticating the first fingerprint and responsively sensing and storing a second fingerprint of a second user;
transmitting the activation code to a moveable barrier operator upon subsequent authenticating of the second fingerprint;
subsequently re-sensing and authenticating the second fingerprint and responsively sensing and storing a third fingerprint of a third user;
transmitting the activation code to the moveable barrier operator upon subsequent authenticating of the third fingerprint.

2. The method of claim 1 comprising selecting and entering a storage mode after authenticating either the second finger print or the third fingerprint.

3. The method of claim 1 comprising upon erasing all of the fingerprints in storage from the memory, changing the activation code.

4. The method of claim 1 comprising upon erasing one or more of the fingerprints in storage from the memory, changing the activation code.

5. The method of claim 1 wherein the activation code is selected from a group comprising a rolling code and a fixed code.

6. A method of operating a moveable barrier operator comprising using a fingerprint authorizing apparatus:
sensing and storing a first fingerprint of a first user in a memory, and authorizing the transmission of an activation code;
subsequently sensing a second fingerprint of a second user and re-sensing and authenticating the first fingerprint and responsively storing the second fingerprint;
transmitting the activation code to a moveable barrier operator upon subsequent authenticating of the second fingerprint;
subsequently sensing a third fingerprint of a third user and re-sensing and authenticating the second fingerprint and responsively storing the third fingerprint;
transmitting the activation code to the moveable barrier operator upon subsequent authenticating of the third fingerprint.

7. The method of claim 6 comprising allowing storage of a fourth fingerprint after authenticating either the second finger print or the third fingerprint.

8. The method of claim 6 comprising upon erasing all of the fingerprints in storage from the memory, changing the activation code.

9. The method of claim 6 comprising upon erasing one or more of the fingerprints in storage from the memory, changing the activation code.

10. The method of claim 6 wherein the activation code is selected from a group comprising a rolling code and a fixed code.

11. A method of operating a moveable barrier operator using a fingerprint authorizing apparatus comprising:
sensing and storing a first fingerprint of a first user in a memory, authorizing the transmission an activation code and enabling future fingerprint authorizations;
subsequently sensing a second fingerprint of a second user and the first fingerprint authorizing the storing of the second fingerprint;
transmitting the activation code to the moveable barrier operator upon subsequent authenticating of the second fingerprint;
subsequently sensing a third fingerprint of a third user and the second fingerprint authorizing the storing of the third fingerprint; and
transmitting the activation code to the moveable barrier operator upon subsequent authenticating of the third fingerprint.

12. The method of claim 11 comprising allowing storage of a fourth fingerprint after authenticating either the second finger print or the third fingerprint.

13. The method of claim 11 comprising upon erasing all of the fingerprints in storage from the memory, changing the activation code.

14. The method of claim 11 comprising upon erasing one or more of the fingerprints in storage from the memory, changing the activation code.

15. The method of claim 11 wherein the activation code is selected from a group comprising a rolling code and a fixed code.

16. A method of operating a moveable barrier operator using a fingerprint authorizing apparatus comprising:
sensing and storing a first fingerprint of a first user in a memory, authorizing the transmission of an activation code and enabling future fingerprint authorizations;
subsequently sensing a second fingerprint of a second user, a third fingerprint of a third user and the first fingerprint authorizing the storing of the second and third fingerprint; and
transmitting the activation code to the moveable barrier operator upon subsequent authenticating of either the second or third fingerprint.

17. The method of claim 16 comprising allowing storage of a fourth fingerprint after authenticating either the second finger print or the third fingerprint.

18. The method of claim 16 comprising upon erasing all of the fingerprints in storage from the memory, changing the activation code.

19. The method of claim 16 comprising upon erasing one or more of the fingerprints in storage from the memory, changing the activation code.

20. The method of claim 16 wherein the activation code is selected from a group comprising a rolling code and a fixed code.

21. A device for operating a moveable barrier operator comprising:
a memory that is arranged and configured to store an activation code;
a fingerprint reading apparatus;
a transmission device having an output;
a controller coupled to the memory, the fingerprint reading apparatus, and the transmission device, the controller being configured and arranged to store a first fingerprint of a first user in the memory that was sensed at the fingerprint reading apparatus, and authorize the transmission of an activation code, the controller arranged and configured to subsequently authenticate the first fingerprint re-sensed at the fingerprint reading apparatus and responsively store a second fingerprint of a second user sensed at the fingerprint reading apparatus, the controller arranged and configured to transmit the activation code to a moveable barrier operator at the output of the transmission device upon authenticating of the second fingerprint, the controller arranged and configured to subsequently authenticate the second fingerprint re-sensed at the fingerprint reading apparatus and responsively store a third fingerprint of a third user sensed at the fingerprint reading apparatus, the controller arranged and configured to transmit the activation code to the moveable barrier operator at the output of the transmission device upon subsequent authenticating of the third fingerprint.

22. The device of claim 21 wherein the controller is configured and arranged to select and enter a storage mode after authenticating either the second finger print or the third fingerprint.

23. The device of claim 21 wherein the controller is arranged and configured to erase all fingerprints from the memory, upon erasing all of the fingerprints from the memory, change the activation code.

24. The device of claim 21 wherein the controller is arranged and configured to upon erasing one or more of the fingerprints in storage from the memory, change the activation code.

25. The device of claim 21 wherein the activation code is selected from a group comprising a rolling code and a fixed code.

26. A device for operating a moveable barrier operator comprising:
a memory that is arranged and configured to store an activation code;
a fingerprint reading apparatus;
a transmission device having an output;
a controller coupled to the memory, the fingerprint reading apparatus, and the transmission device, the controller arranged and configured to store a first fingerprint of a first user in the memory that has been sensed at the fingerprint reading apparatus, and authorizing the transmission of an activation code, the controller arranged and configured to authenticate the first fingerprint that has been re-sensed at the fingerprint reading apparatus and responsively store a second fingerprint that has been previously sensed at the fingerprint reading apparatus, the controller arranged and configured to transmit the activation code to a moveable barrier operator at the output of the transmission device upon authenticating of the second fingerprint, the controller configured and arranged to subsequently responsively store a third fingerprint in the memory after the second print has been re-sensed at the fingerprint reading apparatus and re-authenticated, the controller configured and arranged to transmit the activation code to the moveable barrier operator upon authenticating the third fingerprint.

27. The device of claim 26 wherein the controller is configured and arranged to select and enter a storage mode after authenticating either the second finger print or the third fingerprint.

28. The device of claim 26 wherein the controller is arranged and configured to erase all the fingerprints from memory, and upon erasing all of the fingerprints in storage from the memory, change the activation code.

29. The device of claim 26 wherein the controller is configured and arranged to erase one or more of the fingerprints in storage from the memory and change the activation code.

30. The device of claim 26 wherein the activation code is selected from a group comprising a rolling code and a fixed code.

31. A device for operating a moveable barrier operator comprising:
a memory that is arranged and configured to store an activation code;
a fingerprint reading apparatus;
a transmission device having an output;
a controller coupled to the memory, the fingerprint reading apparatus, and the transmission device, the controller being configured and arranged to store a first fingerprint of a first user in the memory that has been sensed at the fingerprint reading apparatus, authorize the transmission an activation code, and enable future fingerprint authorizations, the controller arranged and configured to subsequently store a second fingerprint of a second user in the memory, the first fingerprint authorizing the storing of the second fingerprint, the controller arranged and configured to transmit the activation code to the moveable barrier operator at the output of the transmission device upon subsequent authenticating of the second fingerprint, the controller arranged and configured to subsequently store a third fingerprint of a third user in the memory, the second fingerprint authorizing the storing of the third fingerprint, the controller being arranged and configured to transmit the activation code to the moveable barrier operator at the output of the transmission device upon subsequent authenticating of the third fingerprint.

32. The device of claim 31 wherein the controller is configured and arranged to select and enter a storage mode after authenticating either the second finger print or the third fingerprint.

33. The device of claim 31 wherein the controller is arranged and configured to erase all of the fingerprints from memory and, upon erasing all of the fingerprints from the memory, change the activation code.

34. The device of claim 31 wherein the controller is arranged and configured to erase one or more of the fingerprints in storage from the memory and change the activation code.

35. The device of claim 31 wherein the activation code is selected from a group comprising a rolling code and a fixed code.

36. A device for operating a moveable barrier operator comprising:
a memory that is arranged and configured to store an activation code;
a fingerprint reading apparatus;
a transmission device having an output;
a controller coupled to the memory, the fingerprint reading apparatus, and the transmission device, the controller being configured and arranged to store a first fingerprint of a first user in the memory that has been sensed at the fingerprint reading apparatus and authorize the transmission of an activation code and enabling future fingerprint authorizations, the controller being arranged and configured to subsequently sense a second fingerprint of a second user and a third fingerprint of a third user at the fingerprint reading apparatus wherein the authenticated first fingerprint authorizes the storing of the second fingerprint and the third fingerprint, the controller arranged and configured to transmit the activation code to the moveable barrier operator at the output of the transmission device upon the subsequent authentication of either the second or third fingerprint.

37. The device of claim 36 wherein the controller is configured and arranged to select and enter a storage mode after authenticating either the second finger print or the third fingerprint.

38. The device of claim 36 wherein the controller is arranged and configured to erase all fingerprints from the memory, and upon erasing all of the fingerprints from the memory, change the activation code.

39. The device of claim 36 wherein the controller is arranged and configured to erase one or more of the fingerprints in storage from the memory and change the activation code.

40. The device of claim 36 wherein the activation code is selected from a group comprising a rolling code and a fixed code.
